(19) United States
(12) Patent Application Publication
(10) Pub. No.: US 2026/0324591 A1
(43) Pub. Date: Oct. 22, 2026

(54) ShamPup Integrated Refillable Pet Grooming Brush with Built-in Shampoo Dispensing Mechanism

(71) Applicant: Danny Katz, Encino, CA (US)

(72) Inventor: Danny Katz, Encino, CA (US)

(21) Appl. No.: 19/184,021

(22) Filed: Apr. 21, 2025

(51) Int. Cl. A01K 13/00; A46B 5/02; A46B 7/04; A46B 11/00; A46B 15/00

(52) U.S. Cl. CPC A01K 13/002; A46B 5/021; A46B 7/04; A46B 11/002; A46B 11/0062; A46B 11/0086; A46B 11/0089; A46B 11/0096; A46B 15/0089; A46B 2200/1093

(57) ABSTRACT

Disclosed herein a a grooming device, primarily for pets such as dogs, known as ShamPup. It features an integrated, refillable shampoo holding tank, a uniquely engineered three-in-one grip knob mechanism, and a replaceable silicone brush pad. The knob doubles as a screw-in cap, ergonomic handle, and push-button actuator. When pressed, a spring-loaded pin mechanism dispenses shampoo directly onto the pet. This design allows for one-handed operation, precise shampoo application, and easy refilling. The device is shaped in a dog paw style to the device is replaceable for hygienic upkeep and long-term use. The ShamPup streamlines grooming by combining brushing and cleaning into a single step, reducing mess and effort for pet owners while improving the bathing experience for animals.

### BACKGROUND

### Field of the Invention

This invention relates to the field of pet grooming, specifically to handheld grooming tools designed for applying cleaning liquids or shampoos directly onto a pet during the brushing process. The invention uniquely integrates a refillable liquid container within the brush itself, eliminating the need for separate bottles or applicators. It further enhances ease of use and ergonomic control with a multifunctional grip system that allows shampoo dispensing directly through the brush pad during grooming. The invention primarily targets the pet care industry but may be adapted for other similar cleaning uses.

### Description of the Related Art

Over the past several decades, the field of pet care has undergone significant evolution. Pet ownership, particularly of dogs, has transcended functional roles of companionship and security to become an integral aspect of family life and well-being. With this cultural shift, there has been a parallel rise in consumer awareness and expectations concerning pet hygiene and grooming. Regular grooming is no longer viewed as an optional luxury but rather as a critical component of responsible pet ownership, directly impacting a pet's health, comfort, and appearance. Grooming helps prevent matting, skin conditions, and infestations, and can often be an early detection point for underlying health issues.

One of the essential aspects of grooming is bathing, which presents a logistical and emotional challenge for many pet owners. Dogs, in particular, may resist water exposure, and their thick coats and variable behavior during washing make the bathing process time-consuming and messy. Traditional bathing involves multiple steps—wetting the dog, applying shampoo manually or from a bottle, working it into the coat with fingers or a brush, and then rinsing thoroughly. Each of these steps requires separate tools, hand movements, and substantial effort to maintain control over the pet. This complex routine has created a growing demand for tools that consolidate these steps into fewer motions with better efficiency and less mess.

Grooming tools play a vital role in ensuring both the efficacy and experience of pet care. The right tool can reduce time, save shampoo and water, and decrease stress for both the pet and owner. Brushes in particular are important for detangling fur, distributing natural oils, and ensuring that any applied shampoos or conditioners penetrate the coat effectively. However, most current brushes are limited in their utility, designed solely for dry grooming or for use post-bath, lacking any integrated means of liquid application.

The industry has seen a push toward multi-functionality, especially among tools used in the home grooming segment. Pet owners have expressed a clear preference for products that reduce the number of steps, are easy to operate with one hand, and do not intimidate the pet. The efficiency of grooming tools has thus become an industry benchmark, with emphasis placed not just on brush quality but on fluid delivery, ease of use, comfort in grip, and hygienic design. Yet despite this rising demand, few solutions truly integrate the shampooing and brushing functions in a way that is seamless, ergonomic, and pet-friendly.

Recent market analysis underscores the commercial relevance of grooming innovations. According to a 2023 report by Grand View Research, the global pet grooming market was valued at approximately USD 9.5 billion and is projected to exceed USD 15 billion by 2030, with a CAGR of 5.7%. North America leads in terms of market share, driven by high pet ownership rates and increasing spending per pet. In a PetSmart-sponsored consumer survey, over 65% of pet owners stated that they groom their pets at home at least once per month, with 40% reporting doing so more frequently during shedding seasons. However, nearly half of those surveyed reported difficulty applying shampoo, citing slippery bottles, uneven application, and a lack of free hands as the main issues.

Moreover, a 2022 consumer study by APPA (American Pet Products Association) revealed that while 78% of dog owners purchase grooming products, only 12% are satisfied with the all-in-one options currently on the market. These statistics point to both strong consumer demand and notable dissatisfaction with existing solutions—indicating a clear gap and opportunity for innovation.

In response to growing demand, several companies have introduced pet brushes that attempt to integrate liquid-dispensing functionality. Some feature gravity-fed reservoirs within the brush handle, activated by squeezing the body to release the shampoo. Others involve a manual pump action to dispense soap through nozzles embedded in the brush head. While these represent a step in the right direction, they are frequently limited in design. Gravity systems often lack flow control, resulting in either excess or insufficient shampoo application. Pump mechanisms, on the other hand, may require two hands to operate, defeating the goal of simplifying grooming.

A few electric or motorized solutions have also entered the market, involving battery-powered liquid pumps and vibratory brush heads. However, these add significant cost, maintenance, and complexity. Pets may react adversely to noise and vibration, rendering such devices ineffective for anxious or sensitive animals. Moreover, none of the current devices utilize a self-sealing silicone interface at the dispensing point—this omission leads to leakage, shampoo crusting, and an overall decline in hygienic usability.

Despite their limitations, existing products have demonstrated a few notable advantages. Multi-step tools do reduce the number of accessories needed during a bath. They can also promote more uniform shampoo application when properly controlled. Some brushes with integrated reservoirs improve shampoo conservation by applying small, localized doses, which is particularly useful for targeted cleaning. For users bathing larger breeds or multiple dogs, even a partial integration of scrubbing and dispensing can offer substantial convenience. These innovations have nudged the industry forward, confirming the value of multifunctionality. However, their success has also revealed what remains unfulfilled—especially around ergonomics, leak control, ease of cleaning, and intuitive operation.

Despite ongoing efforts in design innovation, users continue to face considerable shortcomings with current pet grooming devices. Chief among these is the lack of effective one-handed operation. Many existing solutions either require continuous squeezing or have awkward activation buttons that are difficult to use with wet hands. Leakage is another common issue—without a sealing mechanism at the outlet, shampoo may drip prematurely or clog after drying. Cleanability is often poor, as some internal components cannot be disassembled, allowing bacteria and mildew to develop.

Ergonomics also remains a major pain point. Many brushes are not designed for natural finger positioning, leading to strain during prolonged use. The grip and shape of the tool often fail to accommodate the various hand sizes of users. Furthermore, for pet owners with arthritic conditions, complex mechanics or stiff push buttons make some products inaccessible. Lastly, very few products address the hygienic need for replaceable parts—particularly the brush head, which collects fur, debris, and residue over time. Once these components degrade, the entire device must be discarded.

The present invention, titled ShamPup Brush and Shampoo Dispenser, is conceived as a comprehensive solution to the many shortcomings described above. It introduces a novel, refillable grooming brush designed specifically for pets—especially dogs—that allows for direct and controlled dispensing of liquid shampoo through a replaceable silicone brush pad. The central feature is an ergonomic, multi-functional knob that serves as a grip, a cap, and an actuator in one. This knob is mechanically connected to a spring-loaded pin housed inside the refillable tank, which, when pressed, releases liquid directly into the brush pad and onto the pet's coat.

Unlike conventional brushes that require external bottles or forceful squeezing, ShamPup's self-contained system provides a clean, one-handed experience. Its replaceable ShamPad is made from flexible, pet-safe silicone and features an X-cut outlet that remains sealed when not in use, preventing drips and maintaining hygiene. The actuator design is inspired by modern handheld grips, offering tactile comfort and precise control during use. The tank is clear for easy shampoo level monitoring and is easily refillable through the screw-top knob. This device redefines ease of use, cleanliness, and effectiveness in the pet grooming domain.

The proposed design offers a transformative improvement over existing products by combining true multi-functionality with user-oriented design. It directly addresses the major user pain points: lack of flow control, ergonomic discomfort, poor hygiene, and awkward handling. By integrating an intuitive push-button system with a self-sealing silicone interface, it delivers shampoo precisely when needed, in a format that is easy to clean, easy to refill, and safe for pets. The ShamPad's modularity allows users to replace only the part that comes into contact with the animal, extending the device's lifespan and reducing waste.

This invention fulfills a significant market gap for a practical, affordable, and fully integrated pet grooming tool. It serves both domestic users who seek ease and comfort during home grooming sessions, and professional groomers who require efficiency, control, and sanitation. Furthermore, its paw-shaped, consumer-friendly appearance makes it instantly recognizable as a pet product—enhancing retail visibility and customer trust. In a market hungry for thoughtful, multifunctional designs, the ShamPup stands as a product that meets the moment with innovation rooted in real-world use cases.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve prior techniques and provide an enhanced grooming device designed for pets.

It is the objective of the invention to ensure provide a grooming device that combines shampoo dispensing and brushing in one ergonomic tool.

A further objective of the present invention is to eliminate the need for separate shampoo bottles during the pet grooming process.

It is also an object of the invention to enable one-handed operation for ease of use during pet washing.

It is further the objective of the invention to deliver controlled amounts of shampoo directly to the pet's coat via an integrated mechanism.

It is also the objective of the invention to ensure hygienic and efficient cleaning with a replaceable silicone brush pad.

The objective of the invention is to provide an ergonomic grip that enhances control and reduces strain during grooming.

It is also the objective of the invention to minimize mess and shampoo waste through direct, localized application.

It is further the objective of the invention to improve pet comfort with soft, flexible silicone bristles.

The invention aims to allow quick and easy refilling of the shampoo tank via a twist-off knob.

It is the objective of the invention to offer an aesthetically pleasing, paw-shaped design clearly intended for pet use, enhancing user experience and marketability.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates the front view of ShamPup brush and shampoo dispenser as per preferred embodiments of the invention.

FIG. 2 illustrates the exploded view of ShamPup brush and shampoo dispenser as per preferred embodiments of the invention.

FIG. 3 illustrates the bottom view of the assembly as per preferred embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates to a handheld pet grooming device that integrates a liquid dispensing mechanism within a brush, which is particularly useful for bathing pets such as dogs. The invention combines a brush, a refillable shampoo reservoir, and a manual dispensing mechanism into a single ergonomic tool. The device enables users to apply shampoo directly to the pet's coat while brushing, streamlining the grooming process and minimizing mess.

As per its preferred embodiments, the grooming device comprises three primary components: the refillable liquid container or tank, the interchangeable silicone brush pad, and a uniquely engineered three-in-one knob mechanism. The knob serves as a cap, a manual actuator, and a grip element. The internal dispensing mechanism operates by applying pressure to the knob, which houses a spring-loaded pin. This pin, when depressed, pushes liquid through the base of the container.

As per its further embodiments, the invention itself is designed to distribute shampoo efficiently. It is made from soft, pet-safe silicone with flexible bristles suitable for massaging and cleaning. The bottom portion of the pad includes a shallow concave recess aligned with a central X-shaped cut. This X-cut is engineered to self-close, remaining sealed when not in use but easily allowing fluid to pass through when the spring pin applies pressure. This design eliminates external nozzles or valves and keeps the dispensing area clean.

As per its further embodiments, the refillable tank is permanently affixed to the main body and made from transparent, BPA-free plastic. This transparency allows the user to see the shampoo level at a glance. Volume indicators are optionally marked on the surface. The tank is filled by unscrewing the central knob, which reveals a wide-mouth port. The knob's threads ensure a secure, leak-resistant seal during use, while its shape allows for comfortable, controlled one-handed operation.

As per its further embodiments, the actuator knob is shaped to resemble ergonomic grips found on mobile phone accessories, fitting easily between the fingers. It contains a vertically aligned metal pin surrounded by a helical coil spring. When pressed, the spring compresses, and the pin is driven downward through the tank outlet, pressing against the concave base of the ShamPad and displacing liquid through the X-shaped slit. Releasing the knob causes the spring to expand, resetting the pin.

As per its further embodiments, the entire device is compact, lightweight, and designed with pet owners in mind. The outer form resembles a stylized dog paw, both for ergonomic reasons and to signal its intended market. The pad and knob are the only removable components, making the device easy to clean and maintain.

As per its further embodiments, in commercial and domestic settings, ShamPup provides clear advantages over traditional grooming tools. It reduces steps during washing, encourages better shampoo coverage, and saves time and shampoo by applying it directly where needed. It also makes the bathing experience less stressful for pets by eliminating harsh squeezing bottles or awkward bowl refills.

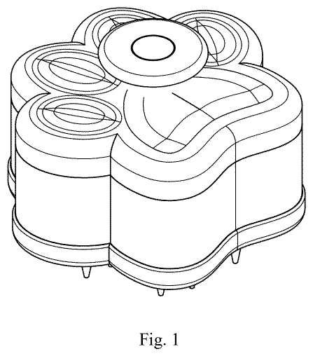

As per its further embodiments, the invention can be understood by the provided images. FIG. 1 shows the external, assembled appearance of the ShamPup grooming device. The design emphasizes the paw-shaped outline, with a centrally located push-knob on top and the soft silicone bristles of the visible on the bottom. The tank body is clear and streamlined, with contoured edges allowing for a better grip during use. The figure captures the ornamental design features intended to appeal to pet owners.

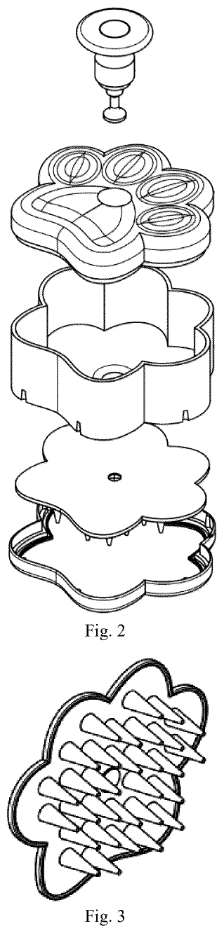

As per its further embodiments, the FIG. 2 illustrates the internal configuration and component assembly. The alignment between the pin and the X-cut in the ShamPad is shown, emphasizing how liquid passes through the system. This view also helps understand how the knob operates as both a cap and an actuator, with the spring coiled around the dispensing pin.

As per its further embodiments, the FIG. 3 shows the bottom view shows the paw-like structure, including the textured bristles arranged in various densities and patterns for effective cleaning. The X-slit is positioned within a concave recess that aligns with the actuator pin, showing how fluid exits the device directly through the base.

As per its further embodiments, the invention is not limited to the embodiments disclosed. While the preferred configuration features a spring-loaded central actuator and self-sealing silicone brush pad, other mechanisms may be substituted, such as twist-valve actuators, alternate spring types, or rubber membranes. The core novelty lies in integrating the dispensing mechanism directly within the grooming tool and its ergonomic combination of structure and function.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A grooming device for pets, comprising:
a body including a refillable liquid container configured to hold a cleaning solution;
a detachable brush pad coupled to the body, the brush pad comprising an elastomeric material and including a dispensing interface; and
a dispensing mechanism comprising a manually operable actuator, a spring-loaded pin, and a sealing cap, wherein actuation of the actuator causes the cleaning solution to be dispensed through the dispensing interface of the brush pad.

2. The pet grooming device of claim 1, wherein the liquid container is transparent and includes volume indiciator on an exterior surface.

3. The pet grooming device of claim 1, wherein the liquid container is permanently affixed to the body and constructed from BPA-free polymeric material.

4. The pet grooming device of claim 1, wherein the actuator is integrated into a rotatable and removable knob configured to seal the container and provide ergonomic grip.

5. The pet grooming device of claim 4, wherein the actuator comprises a push-button centrally located within the knob and operably connected to the spring-loaded pin.

6. The pet grooming device of claim 1, wherein the spring is a helical coil spring positioned concentrically around the pin within the knob.

7. The pet grooming device of claim 1, wherein the dispensing interface comprises an X-shaped slit in the brush pad configured to self-seal when not under pressure.

8. The grooming device of claim 1, wherein the brush pad is removably attachable to the body via a twist-lock or snap-fit engagement.

9. The grooming device of claim 8, wherein the brush pad includes a concave central portion configured to receive the distal end of the pin for controlled dispensing.

10. The grooming device of claim 1, wherein the brush pad is formed in the shape of a paw for ornamental and ergonomic purposes.

11. The grooming device of claim 1, wherein the body and knob are ergonomically shaped for one-handed operation.

12. The grooming device of claim 1, wherein the actuator mechanism allows for direct application of liquid to a pet during brushing, eliminating the need for separate dispensing steps.
